(19) United States
(12) Patent Application Publication
(10) Pub. No.: US 2011/0267809 A1
(43) Pub. Date: Nov. 3, 2011

(54) LIGHTING DEVICE

(75) Inventors: Gunnar KUEHNERT, Kirchdorf (DE); Heinz-Juergen WESSELING, Pfaffing (DE)

(73) Assignee: BLV LICHT- UND VAKUUMTECHNIK GMBH, Steinhoering (DE)

(21) Appl. No.: 13/091,189

(22) Filed: Apr. 21, 2011

(30) Foreign Application Priority Data
Apr. 28, 2010 (DE) 10 2010 018 535.3

(51) Int. Cl. F21V 21/002

(52) U.S. Cl. 362/217.14

(57) ABSTRACT

A lighting device, having a tubular lamp, on each end of which a terminal socket is provided, which has a terminal for electrical contacting of the lamp, and two terminal receptacles associated with the terminal sockets, each having a metal terminal clamp for receiving one of the terminals of the terminal socket, wherein the terminal for the electrical contacting is a strip-shaped metal terminal tab and the terminal clamp has two opposing springy contact surfaces for clamping the terminal tab between them, and wherein opposing front sides of terminal socket and terminal receptacle are adapted to engage in one another in a form-fitting way in an installed state by providing a projection and a depression complementary thereto.

### BACKGROUND OF THE INVENTION

1. Field of the Invention

The invention relates to a lighting device, which is suitable above all for irradiating plants, in particular in greenhouses.

2. Description of Related Art

Lamps, such as discharge lamps, for greenhouses are known from the prior art, which comprise a tubular body and have an exposed lead at each end of the body to connect the lamp. For operation, these lamps are placed in special housings, which clamp the exposed leads between two spring lamellae when the housing is folded closed, and thus, produce a conductive connection.

High-power lamps, for example, 1,000 Watts, are employed for use in greenhouses. It has proven to be problematic in this case that the production of a conductive connection cannot be reliably ensured. In the event of inadequate contact of the leads with the contact lamellae of the housing, because of high (ignition) voltages, which can reach approximately 3,000 V, electric arcs arise between the contact points and result in destruction of the device. The leads can overheat and melt at contact points of the housing due to high currents at these contact points with an excessively small contact surface. Since the contact points are subjected in greenhouses to ambient air which is enriched with moisture and chemicals, for example, fertilizer salts, the conduction at these points is impaired or completely prevented by corrosion of the contact points. In addition, the susceptibility to corrosion of the contact element is additionally increased by high temperatures at the contact points. In practice, since defective lamps cannot be replaced during the vegetation period, their defect can sometimes result in significant harvest losses. Furthermore, it has proven to be problematic according to the prior art that a lamp is unintentionally inserted into a receptacle device which is not intended therefor or its orientation therein in relation to the employed reflector is incorrect, whereby the light yield is reduced or the lamp is even destroyed.

### SUMMARY OF THE INVENTION

A primary object of the present invention is to devise a lighting device which has an improved lifetime over the lighting devices known heretofore, in particular in the case of use under difficult conditions having elevated humidity and temperature strain, as in greenhouses.

To solve this above-mentioned problem, a lighting device of the invention comprises a tubular lamp, on each end of which a terminal socket is provided, which has a terminal for electrically contacting of the lamp, and two terminal receptacles associated with the terminal sockets, each having a metal terminal clamp for receiving one of the terminals of the terminal socket, wherein the terminal for making electrical contact is a strip-shaped metal terminal tab and the terminal clamp has two opposing springy contact surfaces for clamping the terminal tab between them, and wherein opposing front sides of terminal socket and terminal receptacle are adapted to engage in one another in a form-fitting way in an installed state by providing a projection and a depression complementary thereto.

The advantages achieved by the invention are, in particular, that due to the special implementation of lamp sockets and terminal receptacles, and particularly, the elements which produce the electrical contact between the two, the susceptibility to corrosion is significantly reduced and a permanent electrical contact is ensured. This significantly lengthens the lifetime of the lighting device.

An advantageous embodiment allows simple contacting and avoids jamming of the lamp when it is plugged into the terminal receptacles of the lighting device.

A further advantageous embodiment of the invention makes it easier to attach the lamp in the terminal receptacles, in particular if it must be attached overhead.

Particularly reliable contacting while simultaneously avoiding wear of the terminal receptacles when the lamp is changed is achieved by a still further embodiment.

A further advantageous embodiment reduces the temperature impact on the contacts and thus further reduces their wear.

Further measures for increasing the temperature and corrosion stability and for permanent reliable contacting are achieved by another embodiment of the invention.

Further advantageous embodiments ensure correct use of the lamp and prevent the use of an unsuitable lamp.

The measure of a still further embodiment has an advantageous effect on the corrosion resistance of the contact elements.

A further advantageous embodiment allows simple and secure attachment of the lamp.

Another aspect of the invention provides a measure to further reduce the temperature and thus increase the lifetime.

Various exemplary, but non-limiting, embodiments of the invention are shown in the schematic drawings and are described in greater detail hereafter.

### BRIEF DESCRIPTION OF DRAWINGS

FIG. 1 shows an embodiment of a lighting device according to the invention;

FIGS. 2-1 to 2-3 show various embodiments of a terminal clamp;

FIGS. 3-1 to 3-7 show various embodiments of a terminal receptacle;

FIGS. 4-1 to 4-7 show various embodiments of a terminal socket; and

FIGS. 5-1 to 5-7 show various possible arrangements of a seal device on a terminal socket and a terminal receptacle.

### DETAILED DESCRIPTION OF THE INVENTION

The invention is explained hereafter on the basis of the drawings with respect to construction and mode of operation of the illustrated invention. Identical reference numerals identify identical parts.

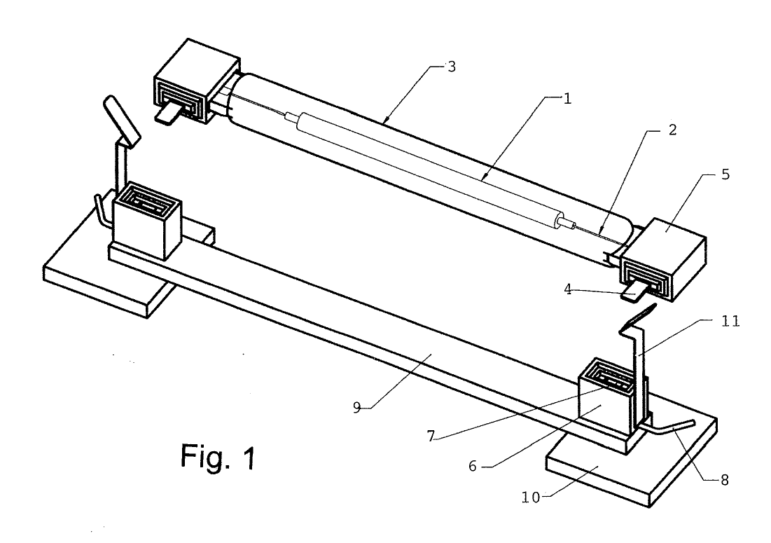

FIG. 1 shows an exemplary embodiment of a lighting device according to the invention, which can be used in greenhouses, for example.

A discharge tube 1 is situated in the interior of a tubular, light-transmitting protective tube 3. A terminal socket 5 is located at each of the two ends of the light-transmitting protective tube 3. Apart from the implementation of the terminal sockets 5, the lamp according to the invention fundamentally corresponds to the typical prior art. A flat, plate-shaped terminal tab 4 protrudes in the radial direction from each terminal socket 5 toward the protective tube 3. The terminal tabs 4 are connected via power lines 2 to the an electrode situated in the interior of discharge tube 1. Electrical contact with the opposing contact surfaces 7 in the terminal receptacle 6, which comprises metal plates, for example, is produced via the terminal tab 4 when it is plugged into the terminal socket 5. The advantage is achieved by plugging or inserting the terminal tab 4 between the contact surfaces 7 that adhering contaminants or oxide layers are rubbed off of the contact surface upon insertion, whereby the resistance and the temperature at the contact point are reduced.

The temperature of the contact elements, i.e., terminal tab 4 and terminal clamp having the contact surfaces 7, can be reduced in that their cross section which is available for electrical conduction is designed in accordance with the employed power. Preferably, the minimal line cross section of the contact elements is therefore at least twice as large as the cross section of one of the electrodes in the discharge tube 1 of the lamp. The cross section is the maximum cross section of the electrode in the discharge tube. The temperatures at the contact point and in the contact elements as a whole may thus be kept low, whereby fusing is prevented and corrosion is reduced.

The contact surfaces 7 and the terminal tab 4 can comprise a corrosion-inhibiting metal, for example, gold or nickel, and/or can be at least partially coated therewith, for example, solely on the contact points which are subjected to the corrosive atmosphere. In addition, the terminal tabs 4 and/or the contact surfaces 7 can be manufactured from a soft metal or coated using such a metal. This has the advantage that the contact resistance between terminal tab 4 and contact surface 7 can be significantly reduced and good contacting can be ensured.

In addition, a mechanical pre-tension can be applied to the opposing contact surfaces 7, which causes the two contact surfaces 7 to be pressed toward one another. The outermost ends of the contact surfaces, which protrude in the direction toward the terminal tab 4, preferably run away from one another again, in order to make it easier to insert the terminal tab between them. The opposing contact surfaces 7 thus have a wedge-shaped opening or widening at their ends for inserting the terminal tab 4. In addition, the terminal tab 4 can be wedge-shaped, so that the terminal tab 4 can be inserted more easily between the contact surfaces 7 and increasingly presses them apart as it is inserted. This has the advantage that a contact having low resistance and high contact surface area is ensured between the terminal tab 4 and the contact surfaces 7. The contact surfaces 7 are preferably connected to one another at their rear ends, from the side facing away from the receptacle side for the terminal tab 4, and form a terminal clamp having two contact surfaces.

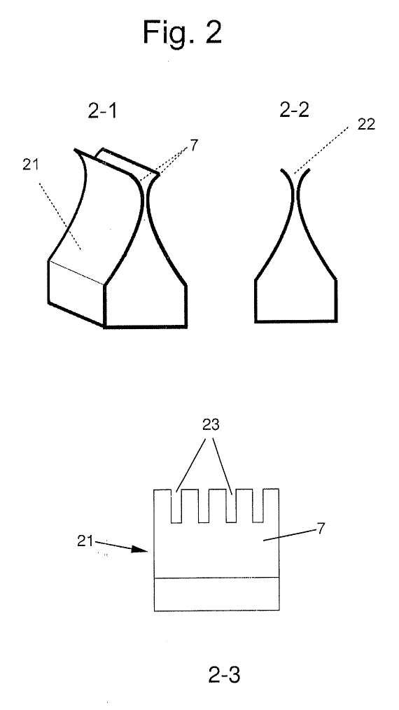

FIG. 2 shows an example of such a terminal clamp 21. At least one of the terminal clamps 21 is preferably mounted floating in the associated terminal receptacle 6, so that it can orient and move itself within a permissible degree of play in relation to the terminal tab 4 to be received. This makes it easier to insert the terminal tab between the contact surfaces 7, which are then pressed with a maximum force uniformly against the inserted terminal tab 4. The advantage is thus achieved that jamming of the lamp can be avoided when it is plugged into the terminal receptacles. This is advantageous in particular if the terminal socket 5 of the lamp first only slides on one side into the terminal receptacle 6. In this case, the advantage is achieved, by the conical opening or widening of the contact surfaces 7 and their being mounted a floating manner, that the terminal socket 5 also can slide easily into the terminal receptacle 6 on the other side of the lamp and jamming is prevented.

Both the terminal socket 5 and also the terminal receptacle 6 are expediently manufactured from a temperature-stable, high-strength, and/or abrasion-resistant material. Both preferably comprise ceramic.

The terminal receptacles 6 are preferably situated at a suitable distance on a carrier 9. In addition, a heat dissipation plate 10 is expediently situated on a carrier, in order to dissipate the heat formed in lamp operation. However, a suitable heat dissipation device can alternatively or additionally be situated at another point, for example, on the contact surfaces 7 and/or on the terminal receptacle 6. In particular, the terminal receptacle 6 and/or the terminal socket 5 can comprise cooling ribs in order to dissipate the heat still better. In addition, the terminal receptacle 6 or the terminal socket 5 can be situated on a metal which has good heat conduction properties, for example, an aluminum plate or an aluminum carrier. This has the advantage that heat which arises at the contacts between the terminal tab 4 and the contact surfaces 7 or due to the discharge tube 1 is effectively dissipated and corrosion of the contact points can be prevented. It has been shown that a temperature reduction by approximately 20° C. results in doubling of the lifetime of the components.

The terminal receptacle 6 and the terminal socket 5 are preferably implemented such that they engage with one another in a complementary way. The areas pressing against one another expediently run diagonally inward or outward, in order to provide the largest possible support surface, without terminal receptacle 6 and terminal socket 5 having to be enlarged unnecessarily. For example, the terminal receptacle 6 can have a recess in the form of a truncated cone or truncated pyramid on the connection side with the terminal socket 5. Correspondingly, the terminal socket 5 can have a complementary bulge or projection in the form of a truncated cone or truncated pyramid on the connection side with the terminal receptacle 6. On the one hand, the advantage is thus achieved that the lamp can easily be guided into the provided contact position when it is plugged in and, on the other hand, a high degree of form fit is achieved using small insertion forces, which seals the connection between terminal socket and terminal receptacle. This prevents corrosive substances in the ambient air from touching the contact surfaces and damaging them.

In addition, sealants can be situated on the terminal receptacle 6 and/or the terminal socket 5, which seal the gap between both parts. In particular, the surfaces of the terminal receptacle 6 or the terminal socket 5 can partially be equipped with inlaid or glued-on, preferably temperature-resistant, permanently elastic materials, such as O-ring seals made of Viton or rubber, for example. Pyramidal surfaces can also be entirely or at least partially implemented as a sealing lip using permanently elastic material. However, flat sealing material and/or sealing lips can also be attached to the terminal receptacle 6 or the terminal socket 5, which comprise Teflon, for example. The seal at the connection point can thus be improved further.

Terminal receptacles 6 and terminal sockets 5 are preferably implemented such that the lamp can only be inserted into the receptacle in a single orientation. This is expediently achieved via a special shaping of the corresponding parts. A manufacturing-related asymmetry of the lamp can be the reason for a specific orientation of the lamp in the receptacle. However, through a suitable reflector, this asymmetry can be compensated for such that it does not cause irregular illumination of the irradiated surface. This presumes a specific arrangement of the lamp adapted to the reflector implementation, however. This predefined orientation is ensured by special shaping of the connection areas of lamp and receptacle. The shape coding can additionally ensure that only a suitable combination of lamp and ballast, reflector, and lighting device is used. The two terminal receptacles 6 can each have recesses, for example, which differ from one another in size and/or shape. Correspondingly, the two terminal sockets 5 can each have projections which are complementary to the recesses. In one variant, the footprints of the two terminal receptacles 6 or terminal sockets 5 can each be implemented differently from one another. For example, the number of the corners of the footprints and/or the edge lengths can differ. The orientation of the terminal tab 4 to the terminal socket 5 can also differ depending on the side of the lamp, in order to prevent the terminal tab from being plugged into the wrong terminal socket. In particular, the illustrated terminal tabs 4 can be situated rotated and/or offset in parallel in the terminal socket 5 in comparison to the lamp longitudinal axis. Furthermore, each of the two terminal tabs 4 can be shaped differently from one another. This also applies accordingly for the terminal clamps 21.

In order to prevent the lamp from falling out of the lighting device, at least one holding device is provided for holding the lamp in the receptacle. This holding device can comprise a catch device, for example, which is provided on the terminal socket and/or on the terminal receptacle. These mounting devices can be implemented, for example, by a tongue-and-groove element, in which a corresponding lug of the terminal socket 5 engages in a matching recess in the terminal receptacle 6 and catches therein or vice versa. The holding device can also be integrated in the terminal tab and/or contact elements, however, and comprise a groove or protrusion in the terminal tab 4 and a correspondingly shaped raised area or a recess in a contact surface 7, so that these catch in one another. Spring elements 11 are also possible, as shown in FIG. 1, which engage over the entire terminal receptacle 6 or the terminal socket 5 and catch on their rear side. Such holders have the advantage that they are externally accessible and may be disengaged manually without a large application of force. The danger is therefore low that the fastening of the light arrangement, frequently a cable hoist structure which can only be loaded slightly, will be damaged by pulling the lamp out of the socket.

FIG. 1 shows a holding spring plate. 11, which is provided on one side of the terminal receptacle 6 as a retainer and protrudes beyond the terminal socket 5. This holding spring plate 11 can be pressed to the side to remove the lamp. In particular, the holding spring plate 11 is shaped such that it automatically bends outward upon insertion of the lamp and then catches behind the terminal socket 5. In addition, the holding spring plate 11 can be designed in such a way that protrusions of the holding spring plate are used as an insertion aid upon insertion. This has the advantage that the force for removing and inserting the lamp is low, the lamp can be securely fastened by locking the holding spring plate 11, and it can be easily removed by unlocking the holding spring plate 11. Since the lamp is typically inserted overhead, the holding spring plate 11 can be implemented having long tabs as a centering aid for easy insertion of the lamp.

The power supply of the devices and a connection to a suitable ignition circuit or a ballast device are ensured via corresponding power lines 8. The arrangement fundamentally corresponds to the prior art, so that it does not have to be described in greater detail here.

FIG. 2 shows various embodiments of a terminal clamp and a terminal tab which is suitable for the terminal clamp. FIG. 2-1 shows a perspective view of the terminal clamp 21 having two opposing contact surfaces 7. FIG. 2-2 shows a side elevational view of the terminal clamp 21 and the widening 22 of the contact surfaces 7 at the terminal opening. The terminal clamp is manufactured from a single sheet-metal strip and is essentially U-shaped. The two U-legs are extend toward one another in a curve in the middle area, in order to have the outermost ends run away from one another again. The wedge-shaped expansion 22 thus formed makes it easier to insert the terminal tab 4, which is then clamped between the curved sections.

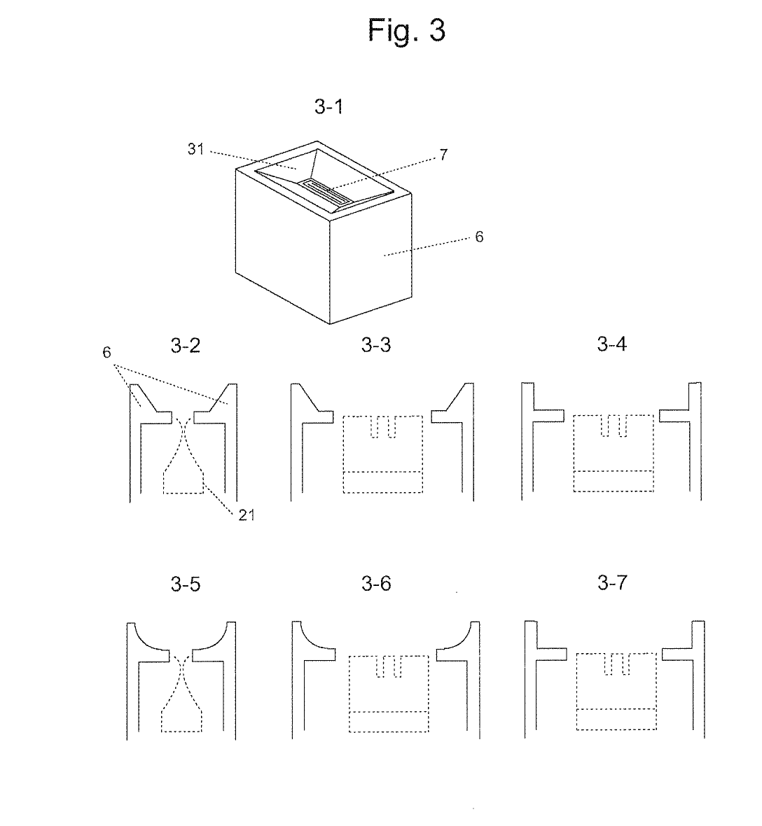

FIG. 2-3 shows an elevational view of the long side of a refinement of the terminal clamp 21. The contact surfaces 7 of the terminal clamp 21 are provided on their free ends with oblong recesses 23 and implemented like combs. The contact pressure between the contact surfaces 7 can be intentionally set via the number and size of these recesses. Easier adaptation to an inserted terminal tab 4 is also possible.

FIG. 3 shows various embodiments of a terminal receptacle 6, which receives the terminal clamp 21 having the contact surfaces 7.

FIG. 3-1 shows a perspective view of a terminal receptacle 6 having the contact surfaces 7 lying in the interior of the terminal receptacle 6 and a spatial recess 31 in the form of a truncated pyramid, which presses against the connection side having a corresponding terminal socket 5 and contacts it in the installed state of the lamp in the area of the recess.

FIGS. 3-2 to 3-7 show various possible designs of the recess, in which the special shaping prevents an incorrect lamp from being installed in the receptacle. FIG. 3-2 shows a cross section through the upper part in the middle of the terminal receptacle 6 with the terminal clamp 21 situated in the interior. The side facing toward the terminal socket 5 is partially beveled toward the inside in the transverse direction, so that a recess having trapezoidal cross section results. FIG. 3-3 shows the arrangement of FIG. 3-2 in longitudinal section. The side facing toward the terminal socket is also partially beveled in the longitudinal direction, so that in combination with the cross section shown in FIG. 3-2, a recess 31 in the form of a truncated pyramid results in the terminal receptacle 6.

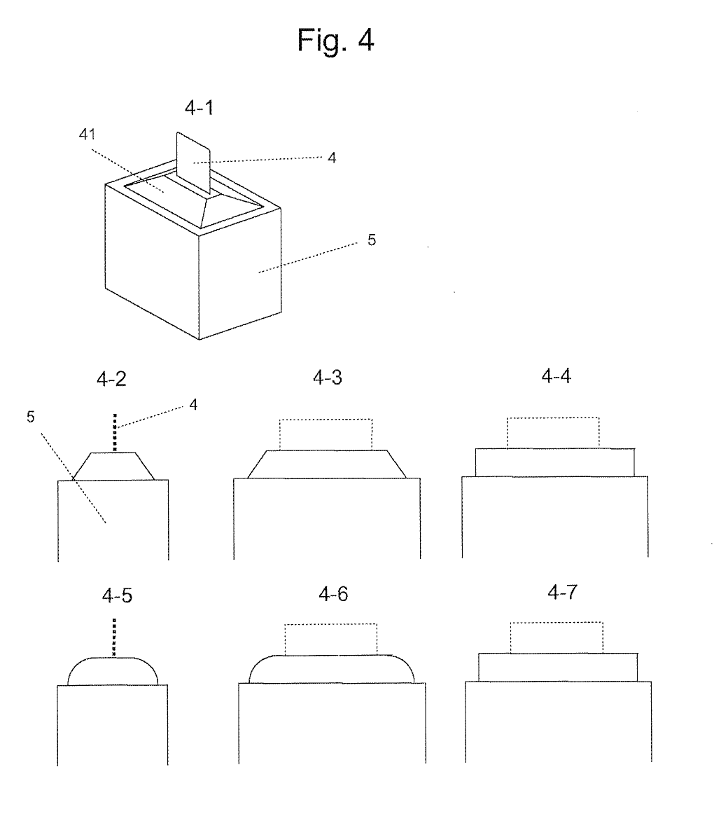

FIG. 3-4 shows another possible design in longitudinal section through the upper part in the middle of the terminal receptacle 6 having the terminal clamp 21 situated in the interior. The side facing toward the terminal socket is stepped perpendicularly in the longitudinal direction. In combination with the cross section shown in FIG. 3-2, a wedge-shaped recess 31 results in the terminal receptacle 6.

FIG. 3-5 shows a further possible design in cross section through the upper part in the middle of the terminal receptacle 6 with the terminal clamp 21 situated in the interior. The side facing toward the terminal socket 5 is partially curved concavely in the transverse direction toward the interior. FIG. 3-6 shows the corresponding longitudinal section. The side facing toward the terminal socket 5 is also partially concavely curved toward the inside in the longitudinal direction, so that a barrel-shaped recess results. FIG. 3-7 shows an alteration of FIG. 3-6. The long sides of the recess are cut off smooth here.

FIG. 4 shows various embodiments of terminal sockets, which are each implemented to engage in a formfitting way in one of the recesses 31 of the terminal receptacles 6 of FIG. 3. FIG. 4-1 shows a perspective view of a terminal socket 5 having the protruding, flat terminal tab 4 and a projection 41 in the form of a truncated pyramid. The terminal socket 5 can be received in the terminal receptacle of FIG. 3-1. FIG. 4-2 shows this terminal socket in cross section, and FIG. 4-3 shows it in longitudinal section.

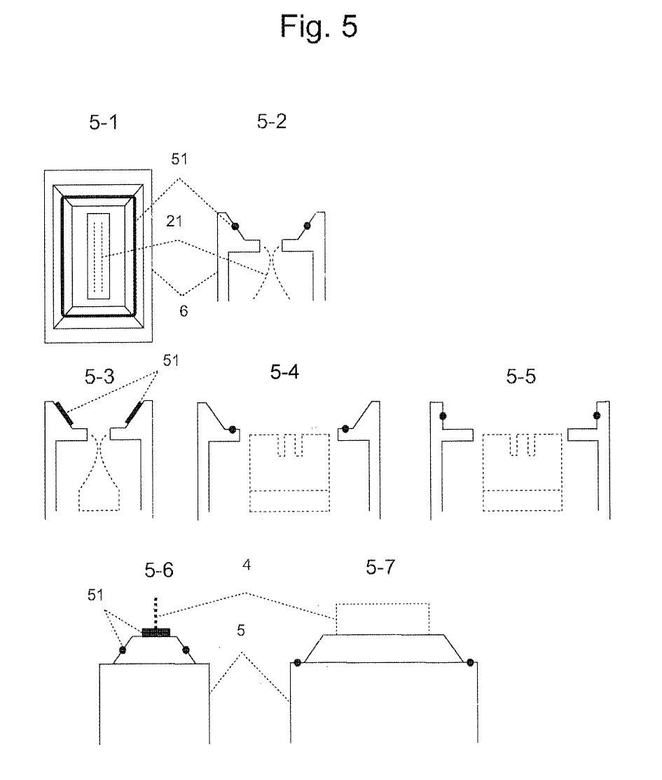

The terminal socket 5 shown in FIG. 4-4 fits in the terminal receptacle according to FIG. 3-4, the terminal socket shown in FIG. 4-5 (cross section) and 4-6 (longitudinal section) fits in the terminal receptacle of FIGS. 3-5 and 3-6. The terminal socket of FIG. 4-7 can be received in the terminal receptacle of FIG. 3-7.

A good form fit is achieved and the connection point is sealed by the embodiments shown of the terminal socket 5 and the terminal receptacle 6. Corrosive substances are thus prevented from entering the terminal receptacle.

FIG. 5 shows various possible arrangements of a seal device on a terminal socket and a terminal receptacle.

FIG. 5-1 shows the connection side of a terminal receptacle 6 having a recess in the form of a truncated pyramid with inlaid terminal clamp 21 in a top view. An O-ring seal 51 is situated in a peripheral groove in the recess in the form of a truncated pyramid. This seal can be a rubber ring or a Viton ring, for example. FIG. 5-2 shows a cross section through the upper part in the middle of the terminal receptacle 6 having the seal 51 shown in FIG. 5-1.

FIG. 5-3 shows an alternative design in cross section through the upper part of the terminal receptacle 6. The seal 51 comprises peripheral flat seal material here, which is attached on the beveled sides of the recess in the form of a truncated pyramid, for example, by gluing.

FIG. 5-4 shows a longitudinal section through the upper part in the middle of the terminal receptacle 6 shown in FIG. 5-1, the seal 51 running around the stump surface of the recess in the form of a truncated pyramid.

FIG. 5-5 shows a longitudinal section of a terminal receptacle 6 as in FIG. 3-4 or 3-7, the seal running around the walls inside the terminal receptacle 6.

FIGS. 5-6 and 5-7 show examples of the attachment of the seal on the terminal socket 5. In the cross section of FIG. 5-6 through the upper part of a terminal socket 5 having a projection in the form of a truncated pyramid, the seal runs around the pyramid surfaces of the projection in the form of a truncated pyramid and is additionally situated flatly on the truncated pyramid surface around the terminal tab 4.

FIG. 5-7 shows a longitudinal section through the upper part in the middle of a terminal socket 5 having a projection in the form of a truncated pyramid, the seal running around the pyramid surfaces of the projection in the form of a truncated pyramid.

All seal arrangements shown can be combined suitably with various forms of the terminal receptacle 6 and the terminal socket 5 such that a seal of the connection point between terminal socket 5 and terminal receptacle 6 results. A still better seal of the connection point in relation to corrosive substances in the ambient air is achieved by the arrangements shown of the seal.

What is claimed is:

1. A lighting device, comprising:
a tubular lamp, on each end of which a terminal socket is provided, which has a terminal, and two terminal receptacles for receiving a respective one of the terminal sockets, each terminal receptacle having a metal terminal clamp for receiving and making electrical contact with the terminal of the respective terminal socket,
wherein the terminal is a strip-shaped metal terminal tab and the terminal clamp has two opposing springy contact surfaces for clamping the terminal tab between them, and wherein opposing front sides of terminal socket and terminal receptacle are shaped to engage with one another in a form-fitting manner in an installed state by the provision of a projection on one of the terminal socket and terminal receptacle and a complementarily shaped depression on the other of the terminal socket and terminal receptacle.

2. The lighting device according to claim 1, wherein the terminal tab protrudes beyond the projection provided on the terminal socket, and wherein the terminal clamp is situated within the depression provided in the terminal receptacle.

3. The lighting device according to claim 2, wherein the terminal clamp is situated floating in the depression.

4. The lighting device according to claim 1, wherein the terminal tabs point radially outward away from a longitudinal axis of the lamp.

5. The lighting device according to claim 4, wherein the terminal tabs taper toward free ends thereof.

6. The lighting device according to claim 1, wherein the terminal clamp is essentially U-shaped, two U-legs forming the contact surfaces being guided toward one another in a middle area and away from one another again at their free ends, thereby forming a constriction in the middle area and a widening at the free ends of the terminal tab.

7. The lighting device according to claim 1, wherein the lamp is a discharge lamp and a cross section of at least one of the terminal tab and the terminal clamp is at least twice as large as a cross section of an electrode of the lamp.

8. The lighting device according to claim 1, which has at least one of the following properties:
at least one of the terminal clamp and the terminal tab are formed of a corrosion-inhibiting metal;
at least one of the terminal clamp and the terminal tab is at least partially coated using a corrosion-inhibiting metal;
at least one of the terminal clamp and the terminal tab are formed using a soft metal;
at least one of the terminal clamp and the terminal tab are at least partially coated using a soft metal;
walls of the terminal receptacle are formed from at least one of a nonconductive high-melting-point and abrasion-resistant material;
walls of the terminal receptacle are formed from ceramic;
walls of the terminal socket are formed from at least one of a nonconductive high-melting-point and abrasion-resistant material, in particular ceramic; and
walls of the terminal socket are formed from ceramic.

9. The lighting device according to claim 1, wherein means are provided to ensure that only a suitable lamp can be used in the terminal receptacles, and the means are selected from at least one of the following:
arrangement of at least one of the terminal tabs at a specific angle relative to a longitudinal axis of the lamp with corresponding arrangement of the corresponding terminal clamp to receive the terminal tab,
special shaping of at least one of the terminal tabs with corresponding shaping of the corresponding terminal clamp to receive the terminal tab,
special shaping of the projection with corresponding shaping of the corresponding depression to receive the projection, and
variation of a footprint of projection and depression.

10. The lighting device according to claim 1, wherein means are provided to ensure that the lamp can only be used in a single orientation in the terminal receptacles, and the means are selected from at least one of the following:
arrangement of at least one of the terminal tabs at a specific angle to a longitudinal axis of the lamp with corresponding arrangement of the corresponding terminal clamp to receive the terminal tab,
special shaping of at least one of the terminal tabs with corresponding shaping of the corresponding terminal clamp to receive the terminal tab,
special shaping of the projection with corresponding shaping of the corresponding depression to receive the projection, and
variation of the footprint of projection and depression.

11. The lighting device according to claim 1, wherein at least one of the terminals socket and the terminal receptacle comprise a sealant for sealing a gap between both parts.

12. The lighting device according to claim 1, wherein at least one holding device is provided in order to removably fasten the lamp on at least one of the terminal receptacles.

13. The lighting device according to claim 12, wherein the holding device is lockable.

14. The lighting device according to claim 1, wherein the terminal receptacles are fastened on a heat-conducting carrier.
